(19) United States
(12) Patent Application Publication
(10) Pub. No.: US 2008/0175241 A1
(43) Pub. Date: Jul. 24, 2008

(54) SYSTEM AND METHOD FOR OBTAINING PACKET FORWARDING INFORMATION

(75) Inventors: Lampros Kalampoukas, Brick, NJ (US); Stephen Fischer, Edison, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UT STARCOM, INCORPORATED, Alameda, CA (US)

(21) Appl. No.: 11/624,444

(22) Filed: Jan. 18, 2007

(51) Int. Cl. H04L 12/56

(52) U.S. Cl. 370/392; 370/401

(57) ABSTRACT

Obtaining packet forwarding data for routing packets. The steps may include (1) receiving packet identification information including a virtual router identifier (VRID) and route data; (2) determining if the VRID of the received packet identification information belongs to a pre-defined set of VRIDs. Additionally, if the VRID of the received packet identification information belongs to the pre-defined set of VRIDs, then the method preferably performs the steps of: (1) converting the VRID into a shortened VRID; and (2) obtaining packet forwarding data by performing a ternary content addressable memory (TCAM) lookup using a short key. But if the VRID of the received packet identification information does not belong to the pre-defined set of VRIDs, then the method performs the step of obtaining packet forwarding data by performing a ternary content addressable memory (TCAM) lookup using a long key.

### FIELD OF THE INVENTION

The present invention relates to a method for obtaining data packet forwarding information for use in a data packet router, data packet switch, or other similar network element.

### BACKGROUND

Data packet routers receive, process, and forward data packets in a data communications network. The high volume of data traffic and the diversity of network protocols in modern data communications networks require data packet routers to process and forward data packets of different protocols very quickly. To process and forward data packets quickly, data packet routers must be able to perform very fast route data lookups of multiple network protocol specific route data to determine where to forward incoming data packets.

Some data packet routers function as a single routing entity. However, other data packet routers may support multiple virtual routers on one physical data packet router, where the data packet router allocates resources among the various virtual routers. A virtual router is an emulation of a physical router at the software and/or hardware level.

Typically, each virtual router supported on a single physical router has its own independent routing and forwarding table and is logically isolated from all other virtual routers on the physical router. This logical separation makes virtual routers ideally suited for Virtual Private Network (VPN) applications.

A VPN is a network service typically purchased by a corporate enterprise from a network service provider for the purpose of providing network connectivity between multiple physical locations on the corporate enterprise's network. A VPN uses various tunneling protocols and/or security mechanisms over the network service provider's shared data network infrastructure to emulate a private line network for the corporate enterprise. A VPN gives the corporate enterprise the network capabilities and security of a private line network, but at a much lower cost because the VPN uses the network service provider's shared data network infrastructure instead of multiple private lines.

A typical VPN architecture includes a virtual router at each location where the corporate enterprise's network interfaces to the network service provider's network. The network service provider configures a VPN which provides logical connectivity between each virtual router in the VPN domain across the network service provider's data network. Each virtual router in the VPN domain forwards data packets to other virtual routers in the VPN domain based on forwarding data stored in a routing table such as a Classless Inter Domain Routing (CIDR) table, a Multi-Protocol Label Switching (MPLS) table, or other routing or forwarding tables of other similar network protocols.

A network service provider may offer VPN service to hundreds or even thousands of different corporate enterprise customers. Each corporate enterprise customer has its own separate VPN, which may correspond to a VPN domain providing connectivity to tens or hundreds of different network locations. Therefore, each data network router in the network service provider's data network may be required to support hundreds or even thousands of virtual routers corresponding to many VPN domains. Consequently, the network service provider's data packet router must be able to perform very fast route data lookups of multiple network protocol specific route data corresponding to hundreds or thousands of virtual routers to determine how to forward incoming data packets through many different VPN domains.

Ternary Content Addressable Memory (TCAM) is one known hardware solution that enables data packet routers to perform very fast route data lookups by using dedicated comparison circuitry to implement a route data lookup function in a single clock cycle. A TCAM compares binary input search data against a table of route data stored in the TCAM matrix and returns the TCAM address of the TCAM entry corresponding to the input search data. The data packet router then uses the output of the TCAM lookup to retrieve forwarding data from a specific location in a separate Random Access Memory (RAM) device. A TCAM is desirable for route data lookups because they can perform lookups very fast; however, TCAMs are generally expensive components and the cost of the TCAM increases dramatically with larger TCAMs to support larger routing and forwarding tables. Thus, the inventors have identified systems and methods to optimize the usage of TCAM devices.

### SUMMARY OF THE INVENTION

Methods of obtaining packet forwarding data are disclosed herein. In the following summary, numerous specific details are set forth to provide a thorough understanding of the invention. However, it is understood that the invention may be practiced without these specific details. Additionally, well-known circuits, structures, standards, and techniques have not been described in detail in order to not obscure the invention.

In a first embodiment, the method of routing packets comprises the steps of: (1) receiving packet identification information including a virtual router identifier (VRID) and route data; (2) determining if the VRID of the received packet identification information belongs to a pre-defined set of VRIDs. Additionally, if the VRID of the received packet identification information belongs to the pre-defined set of VRIDs, then the method preferably performs the steps of: (1) converting the VRID into a shortened VRID; and (2) obtaining packet forwarding data by performing a ternary content addressable memory (TCAM) lookup using a short key. But if the VRID of the received packet identification information does not belong to the pre-defined set of VRIDs, then the method performs the step of obtaining packet forwarding data by performing a ternary content addressable memory (TCAM) lookup using a long key.

In one preferred embodiment, the short key: (1) comprises a shortened VRID and route data; and (2) has a length not greater than a predetermined TCAM key length, where the predetermined key length is equal to the width of the TCAM such that one short key may be stored in one horizontal TCAM row thus maximizing the density of the entries stored in the TCAM matrix. The long key preferably comprises a full-length VRID and route data. The route data portion of each value stored in the short keys and long keys may be an IP address, an MPLS header, an Ethernet MAC address, an ATM header, or any other similar route data.

In a preferred embodiment, the step of determining whether the VRID belongs to a pre-defined set of VRIDs and converting the VRID to a shortened VRID further comprises the steps of: (1) performing a TCAM lookup in a VRID conversion TCAM; and (2) using the VRID to obtain the shortened VRID. Alternatively, the conversion to obtain the shortened VRID may be performed by a table lookup, a hash-based lookup function, or similar mapping process.

In a second embodiment, the method of obtaining packet forwarding data comprises the steps of: (1) storing an index in a conversion TCAM; (2) storing first and second sets of lookup values in a forwarding table TCAM; (3) receiving incoming packet identification information; (4) processing incoming packet identification information to create a first search word; (5) performing a first lookup on the first search word in the conversion TCAM, wherein the output of the first lookup is used to create a second search word; (6) processing the output of the first lookup to create a second search word; and (7) performing a second lookup on the second search word in the forwarding table TCAM, wherein the output of the second lookup is used to obtain packet forwarding data.

The incoming packet identification information preferably comprises a VRID and route data, wherein the route data may be an IP address, an MPLS header, an Ethernet MAC address, an ATM header, or other similar route data.

The first set of lookup values preferably has a short key comprising a shortened VRID and route data. The second set of lookup values preferably has a long key comprising a full-length VRID and route data. The route data portion of each lookup value in both the first and second sets of lookup values having short keys and long keys, respectively, may be an IP address, an MPLS header, an Ethernet MAC address, an ATM header, or any other similar route data.

In a preferred embodiment, the lookup index stored in the conversion TCAM is a list of full-length VRIDs. The quantity of full-length VRIDs stored in the lookup index in the conversion TCAM is preferably some factor of two, such as four, eight, sixteen, thirty-two, etc. The quantity of full-length VRIDs stored in the lookup index need not be a factor of two, but storing a quantity of VRIDs equal to some factor of two is preferable because it maximizes the total quantity of VRIDs that can be represented by the shortened VRID in the short key.

In a preferred embodiment, if the first search word is found during the first lookup in the conversion TCAM, then the second search word comprises: (1) a shortened VRID obtained from the output of the first lookup; and (2) route data. But if the first search word is not found during the first lookup in the conversion TCAM, the second search word comprises: (1) a full-length VRID; and (2) route data.

In the embodiment comprising both a conversion TCAM and a forwarding table TCAM, the conversion TCAM and the forwarding table TCAM may be two physical TCAMs, or alternatively may be two logical subdivisions of a single physical TCAM.

In a third embodiment, the method of obtaining packet forwarding data comprises the steps of: (1) defining a first set of virtual routers; (2) defining a second set of virtual routers; (3) assigning the route data of the first set of virtual routers to a first set of lookup values having a short key; (4) assigning the route data of the second set of virtual routers to a second set of lookup values having a long key; (5) receiving incoming packet identification information including a VRID and route data; and (6) if the VRID of the incoming packet identification information corresponds to a virtual router in the first set, then performing a lookup in the first set of lookup values using a short key; or if the VRID of the incoming packet identification information does not correspond to a virtual router in the first set, then performing a lookup in the second set of lookup values using a long key.

An alternative embodiment further comprises the steps of: (1) storing the VRIDs of the virtual routers in the first set into a conversion TCAM; (2) storing the first and second sets of lookup values into a forwarding table TCAM; and (3) determining if the VRID of the incoming packet identification information corresponds to a virtual router in the first set by looking up the VRID of the incoming packet identification information in the conversion TCAM. In this embodiment, the conversion TCAM and the forwarding table TCAM may be two physical TCAMs, or alternatively may be two logical subdivisions of a single physical TCAM.

The route data portion of each lookup value in both the first and second sets of lookup values having short keys and long keys, respectively, may be an IP address, an MPLS header, an Ethernet MAC address, an ATM header, or any other similar route data.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

Exemplary embodiments of the present invention are described herein with reference to the drawings in which:

FIG. 1 illustrates a simplified block diagram of a data packet router which may use the preferred systems and methods to support very fast packet forwarding data lookups for a plurality of virtual routers, where each virtual router stores packet forwarding data in a common packet forwarding data lookup sub-system.

FIG. 2 illustrates a block diagram of a packet forwarding data lookup sub-system.

FIG. 3A illustrates a detailed block diagram of the first stage of a two-stage packet forwarding data lookup sub-system.

FIG. 3B illustrates a detailed block diagram of the second stage of a two-stage packet forwarding data lookup sub-system.

FIG. 4 illustrates examples of TCAM keys that may be used with a packet forwarding data lookup sub-system.

FIG. 5 illustrates of one embodiment of a preferred method, showing a series of steps performed to obtain packet forwarding data.

FIG. 6 illustrates a second embodiment of a preferred method, showing a series of steps performed to obtain packet forwarding data.

FIG. 7 illustrates a third embodiment of the preferred method, showing a series of steps performed to obtain packet forwarding data.

### DETAILED DESCRIPTION

Described herein is a system and method for use with TCAM devices to perform very fast routing table lookups for the hundreds or even thousands of virtual routers implemented on a single physical router. In one application of the preferred embodiments, a single physical router may be located at a network service provider's network location, and may interface with hundreds of corporate enterprise networks and therefore support hundreds, or even thousands, of virtual routers, which may correspond to hundreds or thousands of VPN domains. The use of a shared TCAM infrastructure allows very fast routing table lookups. In addition, the TCAM devices required to support multiple routing tables for multiple virtual routers are optimized using the methods described herein to efficiently and cost-effectively manage the many different lookup tables corresponding to the different virtual routers in a single physical routing device.

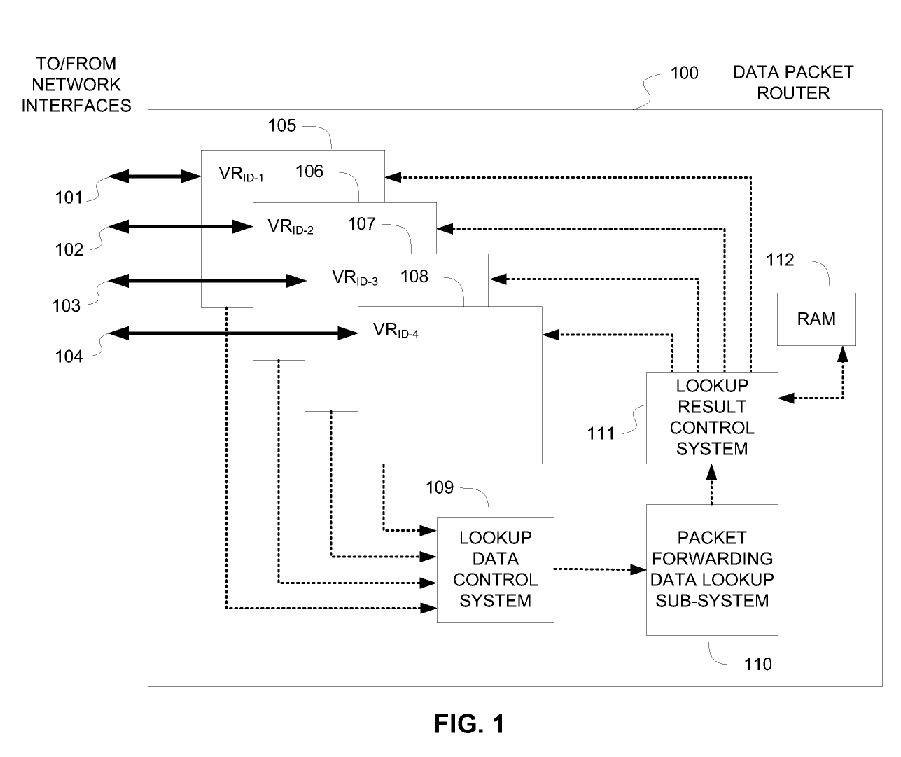

FIG. 1 illustrates a simplified block diagram of a data packet router 100 which may use the disclosed systems and methods to support very fast packet forwarding data lookups. Data packet router 100 supports a plurality of virtual routers 105, 106, 107, 108.

Each of the plurality of virtual routers 105, 106, 107, 108 has a connection 101, 102, 103, 104 to the data packet router 100 network interfaces. When any one of the plurality of virtual routers 105, 106, 107, 108 receives an incoming data packet, the receiving virtual router processes the incoming data packet by separating the packet identification information from the payload of the data packet. The one virtual router of the plurality of virtual routers 105, 106, 107, 108 that received the data packet then sends the packet identification information to the packet forwarding data lookup sub-system 110 via a lookup data control system 109 which prioritizes and buffers lookup requests from the plurality of virtual routers 105, 106, 107, 108. The packet forwarding data lookup sub-system 110 performs the lookup process, generates a lookup result, and sends the result to a lookup result control system 111 which uses the lookup result to obtain packet forwarding data from RAM 112. The lookup result control system 111, after obtaining the packet forwarding data from RAM 112, then sends the packet forwarding data to the one of the plurality of virtual routers 105, 106, 107, 108 that originally requested the packet forwarding data. The one of the plurality of virtual routers 105, 106, 107, 108 then forwards the data packet based on the packet forwarding data.

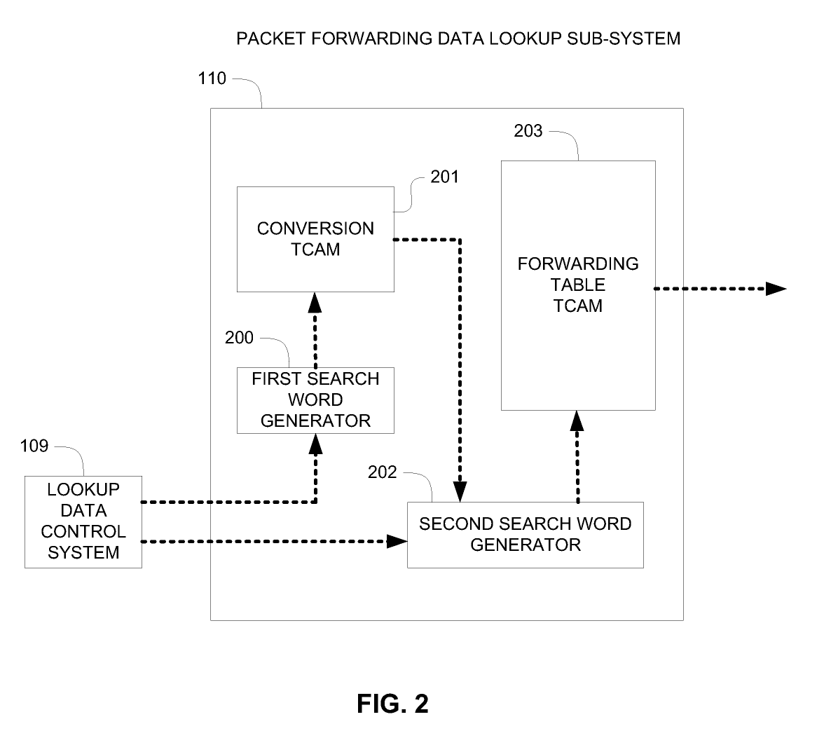

FIG. 2 illustrates a simplified block diagram of a packet forwarding data lookup sub-system 110 that may employ the disclosed invention. Lookup data control system 109 sends packet identification information to a first search word generator 200 and a second search word generator 202. The packet identification information contains a virtual router identifier (VRID) corresponding to the requesting virtual router and route data, where the route data may be an IP address, an MPLS header, a MAC address, an ATM header, or other similar route data. The first search word generator 200 separates the full-length virtual router identifier (VRID) from the route data and sends the full-length VRID to the conversion TCAM 201 for lookup. If the full-length VRID from the first search word generator 200 is found in the conversion TCAM 201, then the conversion TCAM sends a shortened VRID to the second search word generator 202. If the VRID from the first search word generator 200 is not found in the conversion TCAM 201, then the conversion TCAM notifies the second search word generator 202 that the VRID from search word generator 200 was not found.

In alternative embodiments, the conversion is performed using a look up table (LUT), such that if a the full-length VRID is present in the LUT, the shortened VRID is obtained from the LUT. In further alternative embodiments, the shortened VRID may be a hashed value of the full-length VRID. In yet other alternatives, the routers may be assigned VRIDs by the system manager or manually via an operator interface. The assignment process may include assignment of a shortened VRID to a subset of the routers, such that a conversion from long to short VRID is not necessary. Finally, the shortened VRID may be obtained through a combination of range comparison and lookup operations, such as, if the value of the full-length VRID is within a specified range, a base+offset operation may be used to obtain the shortened VRID.

In the embodiment of FIG. 2, if the second search word generator 202 receives a shortened VRID from the conversion TCAM 201, then the second search word generator 202 creates a short key by replacing the full-length VRID of the packet identification information, as originally received from the lookup data control system 109, with the shortened VRID received from the conversion TCAM 201. The short key created by second search word generator 202 contains the shortened VRID from the conversion TCAM 201 and the original route data as received from lookup data control system 109. The second search word generator 202 then sends the short key to the forwarding table TCAM 203 for lookup.

If the second search word generator 202 receives a VRID not-found notification from conversion TCAM 201, the LUT operation, or hash-based lookup, or other VRID conversion process, then the second search word generator 202 creates a long key. The long key contains the full-length VRID and the route data as originally received from lookup data control system 109. The second search word generator 202 then sends the long key to the forwarding table TCAM 203 for lookup.

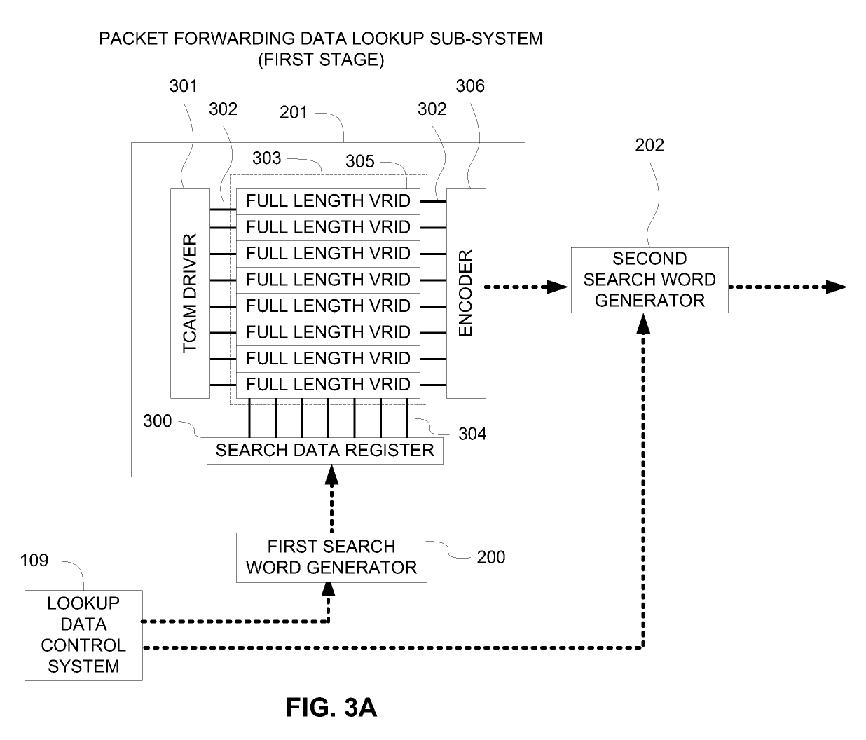

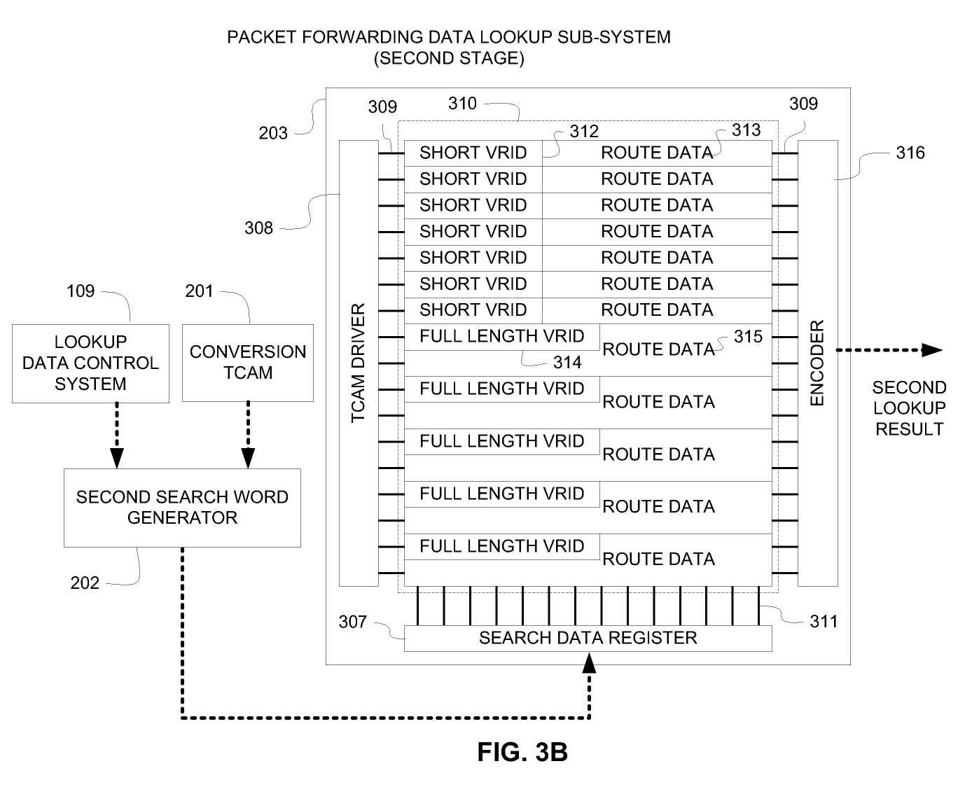

FIG. 3A illustrates a detailed block diagram of the first stage of a two-stage packet forwarding data lookup sub-system. Lookup data control system 109 sends packet identification information to a first search word generator 200 and a second search word generator 202. The packet identification information contains a virtual router identifier (VRID) corresponding to the requesting virtual router and route data, where the route data may be an IP address, an MPLS header, a MAC address, an ATM header, or other similar route data. The first search word generator 200 separates the full-length virtual router identifier (VRID) from the route data and sends the full-length VRID to the conversion TCAM 201 for lookup. Alternatively, lookup data control system 109 may be configured to send only the VRID information to first search word generator 200, while the second search word generator 202 is configured to replace the full length VRID with a shortened VRID when appropriate.

TCAM matrix 303 of conversion TCAM 201 contains keys 305 comprised of full-length VRIDs. Each key 305 is a unique binary string that TCAM matrix 303 of conversion TCAM 201 compares against a search word created by first search word generator 200 during a lookup. When performing a lookup in TCAM matrix 303 of conversion TCAM 201, a search word from the first search word generator 200 is first loaded into search data register 300. The search word is then broadcast from search data register 300 along TCAM searchlines 304 that run vertically in FIG. 3A through each TCAM cell within TCAM matrix 303. For example, searchline Z broadcasts the value of bit Z in search data register 300 to column Z in TCAM matrix 303 such that bit Z of the search word can be compared to bit Z of every key loaded into TCAM matrix 303. TCAM matchlines 302 run horizontally across TCAM matrix 303. At the start of each search process, TCAM driver 301 sets all TCAM matchlines 302 to logical high. Each TCAM cell in a horizontal row of TCAM matrix 303 compares its stored value with the value broadcast on its corresponding searchline 304. If the values match, then that TCAM cell leaves matchline 302 at logical high, but if the values do not match, then that TCAM cell will reset matchline 302 to logical low. If all TCAM cells in a horizontal row of TCAM matrix 303 match the values broadcasted on each of their corresponding TCAM searchlines 304, then the TCAM matchline 302 corresponding to the horizontal row containing the matching entry will remain at logical high, indicating a matching lookup. Conversely, if any TCAM cell in a horizontal row determines that its stored value does match the value broadcast on its corresponding searchline 304, then its corresponding matchline 302 will be at logical low, indicating a mismatch.

If the full-length VRID from the first search word generator 200 is found in the conversion TCAM 201, then the encoder 306 of the conversion TCAM 201 generates a shortened VRID, and the conversion TCAM 201 sends the shortened VRID to the second search word generator 202. But if the VRID from the first search word generator 200 is not found in the conversion TCAM 201, then the conversion TCAM 201 notifies the second search word generator 202 that the VRID from search word generator 200 was not found.

FIG. 3B illustrates a detailed block diagram of the second stage of a two-stage packet forwarding data lookup sub-system that may employ the disclosed invention. Second search word generator 202 receives packet identification information from lookup data control system 109. The packet identification information contains a virtual router identifier (VRID) corresponding to the requesting virtual router and route data, where the route data may be an IP address, an MPLS header, a MAC address, an ATM header, or other similar route data. Second search word generator 202 also receives either a shortened VRID or a VRID not found indication from conversion TCAM 201.

If the second search word generator 202 receives a shortened VRID from the conversion TCAM 201, the LUT, the hash-based lookup, or other conversion process, then the second search word generator 202 creates a short key by replacing the full-length VRID of the packet identification information, as originally received the from lookup data control system 109, with the shortened VRID received from the conversion TCAM 201. The short key created by second search word generator 202 contains the shortened VRID from the conversion TCAM 201 and the original route data as received from lookup data control system 109. The second search word generator 202 then sends the short key to the forwarding table TCAM 203 for lookup.

If the second search word generator 202 receives a VRID not-found notification from conversion TCAM 201, the LUT, hash-based lookup, or other conversion process, then the second search word generator 202 creates a long key. The long key contains the full-length VRID and the route data, preferably as originally received from lookup data control system 109. The second search word generator 202 then sends the long key to the forwarding table TCAM 203 for lookup.

TCAM matrix 310 of forwarding table TCAM 203 preferably has at least two partitions. The first partition contains short keys comprising a shortened VRID 312 and route data 313, where the route data may be an IP address, an MPLS header, a MAC address, an ATM header, or other similar route data. The number of bits in the short key is preferably not greater than the number of bits in a horizontal TCAM row. The second partition contains long keys comprising a full-length VRID 314 and route data 315, where the route data may be an IP address, an MPLS header, a MAC address, an ATM header, or other similar route data. The number of bits in the long key is greater than the number of bits in the short key. The number of bits in the long key is preferably greater than the number of bits in a horizontal TCAM row such that the long key must be stored in at least two horizontal TCAM rows of forwarding table TCAM 203.

When performing a lookup in forwarding table TCAM 203, the second search word generator 202 sends a search word to search data register 307, where the search word is either a short key or a long key based on the result obtained from the first lookup in conversion TCAM 201. Search data register 307 broadcasts the search word along TCAM searchlines 311 that run vertically in FIG. 3B through each TCAM cell within TCAM matrix 310 of forwarding table TCAM 203. For example, searchline Z broadcasts the value of bit Z in search data register 307 to column Z in TCAM matrix 310 such that bit Z of the search word can be compared to bit Z of every key loaded into TCAM matrix 310. At the start of each search process, TCAM driver 308 sets all TCAM matchlines 309 to logical high. Each TCAM cell in a horizontal row of TCAM matrix 310 compares its stored value with the value broadcast on its corresponding searchline 311. If the values match, then that TCAM cell leaves matchline 309 at logical high, but if the values do not match, then that TCAM cell will reset matchline 309 to logical low. If all TCAM cells in a horizontal row of TCAM matrix 310 match the values broadcasted on each of their corresponding TCAM searchlines 311, then the TCAM matchline 309 corresponding to the horizontal row containing the matching entry will remain at logical high, indicating a matching lookup. Conversely, if any TCAM cell in a horizontal row determines that its stored value does match the value broadcast on its corresponding searchline 311, then its corresponding matchline 309 will be at logical low, indicating a mismatch. In the case where “don't care” values cause multiple matches, encoder 316 contains logic that determines and outputs the lookup result corresponding to the best of the multiple key matches.

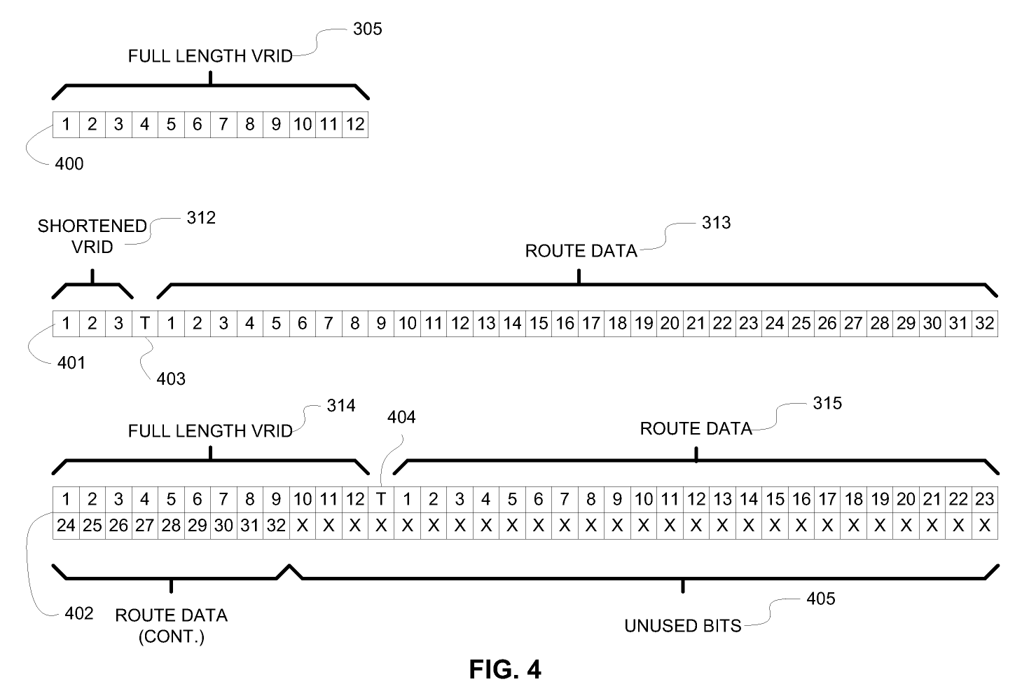

FIG. 4 illustrates examples of different TCAM keys that might be used with a packet forwarding data lookup sub-system; however, other TCAM key structures, though not explicitly described or shown herein, may also be used to obtain packet forwarding data within the scope of the disclosed invention. Index key 400 is stored in the conversion TCAM, or LUT, or the table structure used by the hash-based lookup engine, where the index key 400 comprises a full-length VRID 305. In the embodiment shown in FIG. 4, the full-length VRID is 12 bits long and can represent up to 4096 unique VRIDs. Short key 401 and long key 402 are stored in the forwarding table TCAM. Short key 401 comprises a shortened VRID 312, a packet type identifier 403, and route data 313. In the embodiment shown in FIG. 4, the shortened VRID field is 3 bits and can represent up to 8 unique VRIDs, the packet type identifier field is 1 bit long and can represent up to 2 unique packet types, and the route data field is 32 bits long and thus can accommodate a 32 bit long IPv4 address or a 20 bit long MPLS header.

In other embodiments, the short key may contain more than 36 bits, but in preferred embodiments, the total number of bits in the short key is less than the number of bits in a horizontal row of the forwarding table TCAM. Long key 402 comprises a full-length VRID 314, a packet type identifier 404, and route data 315. In the embodiment shown in FIG. 4, the full-length VRID field is 12 bits long and can represent up to 4096 unique VRIDs, the packet identifier field is 1 bit long and can represent up to 2 unique packet types, and the route data field is 55 bits long and thus can accommodate a 32 bit IP address, as shown, a 20 bit MPLS header, a 48 bit MAC address, or other similar route data. In other embodiments, the long key may contain more or less than 72 bits, but in preferred embodiments, the total number of bits in the long key is preferably less than the number of bits in two horizontal rows of the forwarding table TCAM.

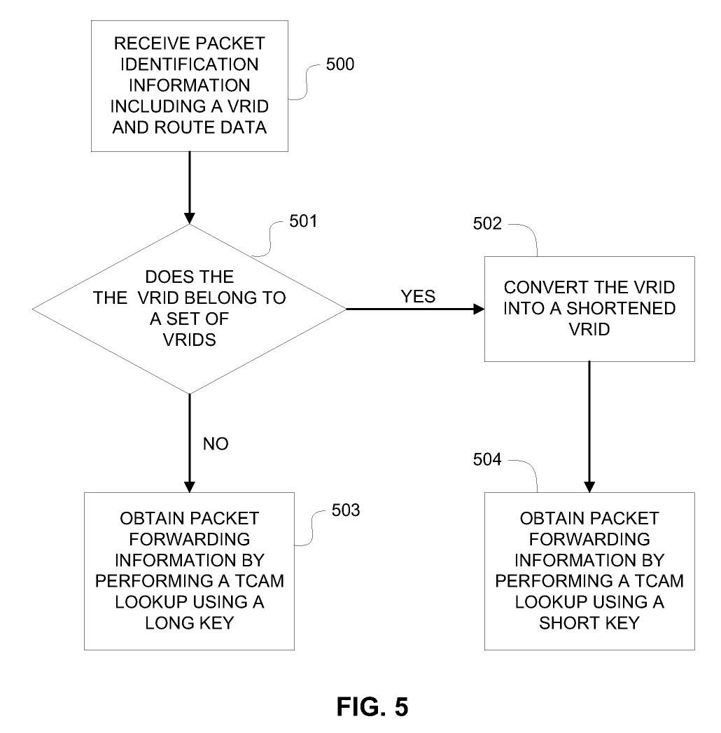

FIG. 5 illustrates one embodiment of a preferred method comprising the steps of: (1) receiving packet identification information including a VRID and route data 500; (2) determining if the VRID belongs to a set of VRIDs 501, and if so: (a) converting the VRID into a shortened VRID 502; and (b) obtaining packet forwarding data by performing a TCAM lookup using a short key 504; and (3) if the VRID does not belong to the set of VRIDs, then (a) obtaining packet forwarding data by performing a TCAM lookup using a long key 503.

In the embodiment illustrated in FIG. 5, the steps of determining if the VRID belongs to a set of VRIDs and converting the VRID into a shortened VRID preferably comprises using the VRID to obtain a shortened VRID by performing a TCAM lookup in a conversion TCAM. In an alternative embodiment, the steps of 501 and 502 may be performed via a microprocessor or microcontroller executing software instructions to perform the conversion, such as by using a look up table (LUT) or a hashing function, or other suitable data conversion or compression process.

The long key of step 503 preferably comprises a full-length VRID and route data, where the route data may be an IP address, an MPLS header, a MAC address, an ATM header, or other similar route data. The short key of step 504 preferably has a length not greater than a predetermined TCAM key length. In a preferred embodiment, the number of bits in the short key of step 504 is not greater then the number of bits in a horizontal TCAM row, such that one horizontal TCAM row can accommodate one short key.

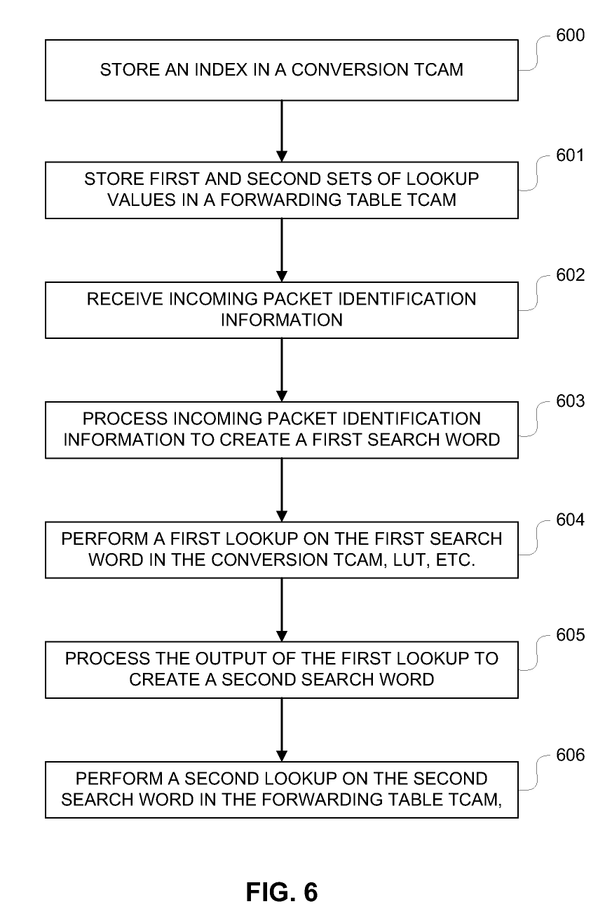

FIG. 6 illustrates another embodiment of a preferred method comprising the steps of: (1) storing an index in a conversion TCAM 600; (2) storing first and second sets of lookup values in a forwarding table TCAM 601; (3) receiving incoming packet identification information 602; (4) processing the incoming packet identification information to create a first search word 603; (5) performing a first lookup on the first search word in the conversion TCAM 604; (6) processing the output of the first lookup to create a second search word 605; and (7) performing a second lookup on the second search word in the forwarding table TCAM 606.

In the embodiment illustrated in FIG. 6, the incoming packet identification information of steps 602 and 603 preferably comprises a VRID and route data, where the route data may be an IP address, an MPLS header, a MAC address, an ATM header, or other similar route data. The index of step 600 preferably comprises a list of full-length VRIDs. The first set of lookup values in step 601 preferably comprises a shortened VRID and route data, where the route data may be an IP address, an MPLS header, a MAC address, an ATM header, or other similar route data. The second set of lookup values in step 601 preferably comprises a full-length VRID and route data, where the route data may be an IP address, an MPLS header, a MAC address, an ATM header, or other similar route data.

If the first search word of step 604 is found during the first lookup in the conversion TCAM (or LUT, or hash-based lookup structure etc.) of step 604, then the second search word of step 605 preferably comprises a shortened VRID and route data, where the shortened VRID is obtained from the output of the first lookup of step 604, and where the route data may be an IP address, an MPLS header, a MAC address, an ATM header, or other similar route data. If the first search word of step 604 is not found during the first lookup in the conversion TCAM of step 604, then the second search word of step 605 preferably comprises a full-length VRID and route data, where the full-length VRID is preferably the same VRID of the packet identification information received in step 602, and where the route data may be an IP address, an MPLS header, a MAC address, an ATM header, or other similar route data. Additionally, the conversion TCAM of steps 600 and 604 and the packet forwarding TCAM of steps 601 and 606 may be either physically separate TCAMs or logical subdivisions of a single physical TCAM.

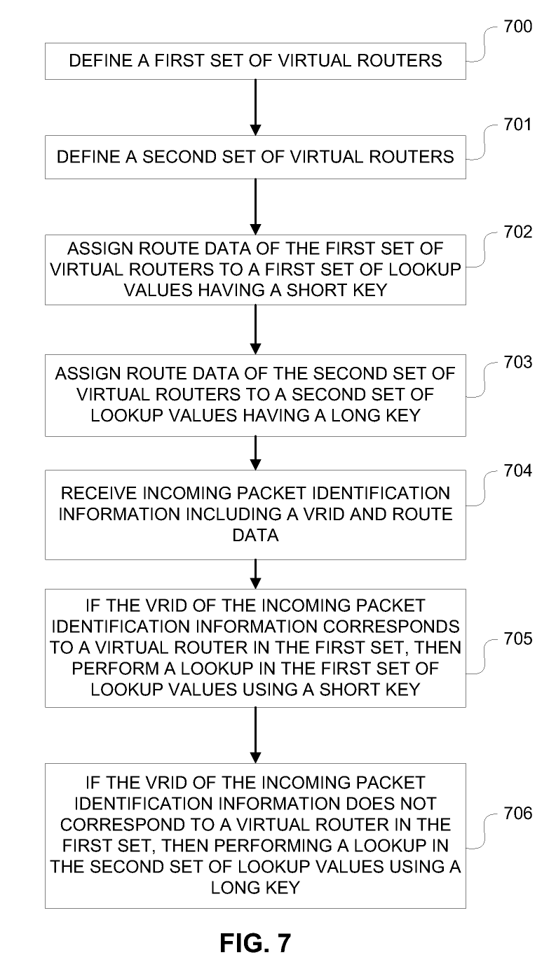

FIG. 7 illustrates a third embodiment of a preferred method comprising the steps of: (1) defining a first set of virtual routers 700, (2) defining a second set of virtual routers 701; (2) assigning route data of the first set of virtual routers to a first set of lookup values having a short key 702; (3) assigning route data of the second set of virtual routers to a second set of lookup values having a long key 703; (4) receiving incoming packet identification information including a VRID and route data 704; (5) if the VRID of the incoming packet identification information corresponds to a virtual router in the first set of virtual routers, then performing a lookup in the first set of lookup values using a short key 705; and (6) if the VRID of the incoming packet identification information does not correspond to a virtual router in the first set, then performing a lookup in the second set of lookup values using a long key 706. The route data of steps 702, 703, and 704 may be an IP address, an MPLS header, a MAC address, an ATM header, or other similar route data.

In one embodiment associated with FIG. 7, the VRIDs of the virtual routers in the first set of step 700 are preferably stored in a conversion TCAM and the first and second sets of lookup values of steps 702 and 703 are preferably stored into a forwarding table TCAM. The conversion TCAM and the forwarding table TCAM may be either physically separate TCAMs or logical subdivisions of a single physical TCAM. Additionally, the embodiment of FIG. 7 may also include a step of determining if the VRID of the incoming packet identification information of step 704 corresponds to a virtual router in the first set of virtual routers of step 700 by looking up the VRID of the incoming packet identification information of step 704 in the conversion TCAM. As an alternative, the lookup and conversion of VRIDs may be performed using a LUT, or various hash-based lookup implementations, or in software, without the use of a conversion TCAM.

In an alternative embodiment, the virtual routers of the first set may be provided with a shortened VRID, which may be used by the virtual routers when requesting forwarding data. As such, in these embodiments, a separate step of converting the VRIDs is not necessary, and the lookups may proceed directly using a shortened key. In these embodiments, the routers that are assigned a short VRID may be selected by a system manager based on historical information relating to the number of routes typically installed by the various routers, or by a manual process via a user interface. The selection of which routers qualify for shortened VRIDs may also be performed dynamically if, over time, some routers have developed a large number of routes worthy of a change of status, in order to optimize the utilization of the lookup table capacity.

Exemplary embodiments of the present invention have been described above. Thus, references to specific architectures and methods are meant to be illustrative rather than limiting. Those skilled in the art will understand that changes and modifications may be made to these embodiments without departing from the true scope and spirit of the invention, which is defined by the claims.

We claim:

1. A method of obtaining packet forwarding data comprising the steps of:
receiving packet identification information including a virtual router id (VRID) and route data;
determining if the VRID belongs to a set of VRIDs, and if so:
converting the VRID into a shortened VRID; and,
obtaining packet forwarding data by performing a ternary content addressable memory (TCAM) lookup using a short key, the short key comprising the shortened VRID and the route data; and
if the VRID does not belong to the set of VRIDs, then obtaining packet forwarding data by performing a ternary content addressable memory (TCAM) lookup using a long key.

2. The method of claim 1 wherein the step of determining if the VRID belongs to a set of VRIDs and converting the VRID comprises performing a TCAM lookup in a VRID conversion TCAM using the VRID to obtain the shortened VRID.

3. The method of claim 1 wherein the long key comprises the VRID and the route data.

4. The method of claim 1 wherein the route data is an IP address.

5. The method of claim 1 wherein the route data is multi protocol label switching (MPLS) data.

6. The method of claim 1 wherein the short key has a length not greater than a predetermined TCAM key length.

7. A method of obtaining packet forwarding data comprising the steps of:
storing an index in a conversion TCAM;
storing first and second sets of lookup values in a forwarding table TCAM;
receiving incoming packet identification information;
processing incoming packet identification information to create a first search word;
performing a first lookup on the first search word in the conversion TCAM, wherein the output of the first lookup is used to create a second search word;
processing the output of the first lookup to create a second search word;
performing a second lookup on the second search word in the forwarding table TCAM, wherein the output of the second lookup is used to obtain packet forwarding data.

8. The method of claim 7 wherein the incoming packet identification information includes a VRID and route data.

9. The method of claim 8 wherein the route data is an IP address.

10. The method of claim 8 wherein the route data is MPLS data.

11. The method of claim 7 wherein the lookup index comprises a list of full-length VRIDs.

12. The method of claim 7 wherein the first set of lookup values has a short key comprising a shortened VRID and route data.

13. The method of claim 7 wherein the second set of lookup values has a long key comprising a full-length VRID and route data.

14. The method of claim 7 wherein the second search word comprises:
if the first search word is found during the first lookup:
a shortened VRID and route data, wherein the shortened VRID is obtained from the output of the first lookup; or
if the first search word is not found during the first lookup:
a full-length VRID and route data.

15. The method of claim 7 wherein the conversion TCAM and the forwarding table TCAM are logical subdivisions of a single physical TCAM.

16. A method of obtaining packet forwarding data comprising the steps of:
defining a first set of virtual routers;
defining a second set of virtual routers;
assigning the route data of the first set of virtual routers to a first set of lookup values having a short key;
assigning the route data of the second set of virtual routers to a second set of lookup values having a long key;
receiving incoming packet identification information including a VRID and route data; and
if the VRID of the incoming packet identification information corresponds to a virtual router in the first set, then performing a lookup in the first set of lookup values using a short key; or
if the VRID of the incoming packet identification information does not correspond to a virtual router in the first set, then performing a lookup in the second set of lookup values using a long key.

17. The method of claim 16 further comprising:
storing the VRIDs of the virtual routers in the first set into a conversion TCAM;
storing the first and second sets of lookup values into a forwarding table TCAM.

18. The method of claim 17 wherein the conversion TCAM and the forwarding table TCAM are logical subdivisions of a single physical TCAM.

19. The method of claim 16 further comprising the step of:
determining if the VRID of the incoming packet identification information corresponds to a virtual router in the first set by looking up the VRID of the incoming packet identification information in the conversion TCAM.

20. The method of claim 16 wherein the route data comprises an IP address.

21. The method of claim 16 wherein the route data comprises MPLS data.
